(19) United States
(12) Patent Application Publication
(10) Pub. No.: US 2023/0328341 A1
(43) Pub. Date: Oct. 12, 2023

(54) INFRARED CAMERA, IMAGE PROCESSING METHOD, AND NON-TRANSITORY RECORDING MEDIUM STORING IMAGE PROCESSING PROGRAM

(71) Applicant: West Nippon Expressway Engineering Shikoku Co. Ltd, Kagawa (JP)

(72) Inventors: Kazuaki HASHIMOTO, Kagawa (JP); Shogo HAYASHI, Kagawa (JP)

(21) Appl. No.: 18/133,016

(22) Filed: Apr. 11, 2023

(30) Foreign Application Priority Data
Apr. 12, 2022 (JP) 2022-065817

(51) Int. Cl. H04N 23/23; H04N 23/84; H04N 23/60

(52) U.S. Cl. CPC H04N 23/23; H04N 23/84; H04N 23/64

(57) ABSTRACT

An infrared camera, comprising: an imaging section that images a subject; and an execution section that executes image processing on a captured image captured by the maging section, wherein: the imaging section includes: an uncooled infrared ray detection section that detects infrared rays radiated from the subject, and a black body section that covers a portion of the infrared ray detection section, and the execution section includes a processor, wherein the processor is configured to: acquire the captured image and a component of noise extracted from the captured image captured at the portion covered by the black body section, and remove the noise component from all of the captured image.

### CROSS-REFERENCE TO RELATED APPLICATION

This application is based on and claims priority under 35 USC 119 from Japanese Patent Application No. 2022-065817 filed on Apr. 12, 2022, the disclosure of which is incorporated by reference herein.

### BACKGROUND

### Technical Field

The present disclosure relates to an infrared camera, an image processing method, and to a non-transitory recording medium storing an image processing program.

### Related Art

In a structure survey method using an infrared camera and disclosed in Japanese Patent Application Laid-Open (JP-A) No. 2008-151809, a surface of a structure is imaged by the infrared camera, so as to survey a damage state of the interior of the structure based on a temperature distribution of the imaged structure surface. The structure survey method determines plural damage pattern images having different depths and shapes of damage portions in the structure interior, associates temperature distribution profiles along a specific axis direction of the structure surface in advance with each of the plural damage patterns, and images the structure surface using an infrared camera. In this structure survey method, a temperature distribution along the specific axis direction of the structure surface is found from the imaging results, and the temperature distribution profile that matches the found temperature distribution is determined, and the damage pattern corresponding to the determined temperature distribution profile is determined as being the actual damage state of the structure.

A temperature difference that arises owing to internal damage of a concrete structure using an infrared thermography method is relatively small. Moreover, the sensitivity of an infrared camera including an uncooled infrared ray detection section installed with a microvoltmeter as a detection element (hereafter referred to as an uncooled camera) is lower than the sensitivity of an infrared camera including a cooled infrared ray detection section (hereafter referred to as a cooled camera), and a lot of noise also arises in captured images therewith. Thus there are sometimes cases in which internal damage of a concrete structure is not able to be detected with an uncooled camera.

### SUMMARY

In consideration of the above circumstances, an object of the present disclosure is to provide an uncooled camera capable of reducing noise of captured images compared to hitherto.

In order to achieve the above objective, an infrared camera according to a first aspect includes an imaging section that images a subject and an execution section that executes image processing on a captured image captured by the imaging section. The imaging section includes an uncooled infrared ray detection section that detects infrared rays radiated from the subject, and a black body section that covers a portion of the infrared ray detection section. The execution section includes an acquisition section that acquires the captured image and a component of noise extracted from the captured image captured at the portion covered by the black body section, and a removal section that removes the noise component from all of the captured image.

Moreover, an infrared camera according to a second aspect is the infrared camera according to the first aspect, wherein the black body section covers a portion of the infrared ray detection section extending in a direction intersecting with a direction in which the noise is generated.

Moreover, an infrared camera according to a third aspect is the infrared camera according to the second aspect, wherein the black body section covers the infrared ray detection section entirely in a direction orthogonal to the noise generation direction and covers the infrared ray detection section only partially in a direction parallel to the noise generation direction.

An infrared camera according to a fourth aspect is the infrared camera according to any one of the first aspect to the third aspect, further including a polarizer, and a drive section for rotating the polarizer. The execution section further includes a rotation section and an estimation section. The rotation section rotates the polarizer by 180° or more by controlling the drive section. The acquisition section acquires plural of the captured images that capture the same subject while rotating the polarizer. The estimation section estimates a temperature estimation model expressed by a cosine function for estimating a temperature of the subject based on respective detected temperatures of the subject as detected from the plural captured images and based on a rotation angle of the polarizer when these respective detected temperatures were detected, and estimates the detected temperature based on the temperature estimation model for a state in which the infrared rays reflected by the subject have been removed to the greatest extent.

An infrared camera according to a fifth aspect is the infrared camera according to the fourth aspect, wherein the rotation section rotates the polarizer at a constant speed.

An infrared camera according to a sixth aspect is the infrared camera according to the fourth aspect or the fifth aspect, wherein the estimation section estimates the detected temperature based on the temperature estimation model for a state in which all of the infrared rays reflected by the subject have been removed.

Moreover, an infrared camera according to a seventh aspect is the infrared camera according to any one of the fourth aspect to the sixth aspect, wherein the estimation section estimates a value obtained by subtracting an absolute value of an amplitude from an offset in the temperature estimation model as being the detected temperature for the state in which the infrared rays reflected by the subject have been removed to the greatest extent.

An image processing method according to an eighth aspect is image processing for execution by a computer, the processing comprising acquiring a captured image captured by an imaging section provided at an infrared camera, acquiring a noise component extracted from the captured image captured at a portion of an uncooled infrared ray detection section provided at the imaging section, the uncooled infrared ray detection section being for detecting infrared rays radiated from a subject, and the portion being covered by a black body section, and removing the noise component from all of the captured image.

An image processing program according to a ninth aspect causes a computer to perform processing including acquiring a captured image captured by an imaging section provided at an infrared camera, acquiring a noise component extracted from the captured image captured at a portion of an uncooled infrared ray detection section provided at the imaging section, the uncooled infrared ray detection section being for detecting infrared rays radiated from a subject, and the portion being covered by a black body section, and removing the noise component from all of the captured image.

The present disclosure is able to reduced noise in a captured image compared to hitherto.

### BRIEF DESCRIPTION OF THE DRAWINGS

Exemplary embodiments of the present disclosure will be described in detail based on the following figures, wherein:

FIG. 1 is a schematic diagram illustrating an example of a configuration of an infrared camera according to a first exemplary embodiment;

FIG. 2. is a block diagram illustrating an example of relevant configuration of an electrical system of an infrared camera according to the first exemplary embodiment;

FIG. 3 is a schematic diagram illustrating an example of a configuration of an infrared ray detection section according to an exemplary embodiment;

FIG. 4 is a block diagram illustrating an example of a hardware configuration of an execution section of the present exemplary embodiment;

FIG. 5 is a functional block diagram illustrating an example of an execution section according to the first exemplary embodiment;

FIG. 6 is a flowchart illustrating an example of image processing according to the first exemplary embodiment;

FIG. 7 is a schematic diagram to explain an example of image processing according to the first exemplary embodiment;

FIG. 8A and FIG. 8B are examples of captured images acquired with an infrared camera according to the first exemplary embodiment merely by changing exposure time alone and without execution of image processing;

FIG. 9 is graph illustrating an example of a detected temperature for a case in which a subject having a fixed temperature has been imaged using a cooled camera and using an infrared camera according to the first exemplary embodiment;

FIG. 10 is a graph illustrating an example of a standard deviation of an evaluation region with respect to a number of images averaged;

FIG. 11 is a graph illustrating an example of a detected temperature for a case in which a subject having a fixed temperature has been imaged using a cooled camera and using an infrared camera according to the first exemplary embodiment;

FIG. 12A to FIG. 12C are examples of a captured image imaged using a cooled camera and using an infrared camera according to the first exemplary embodiment;

FIG. 13 is a schematic diagram illustrating an example of a configuration of an infrared camera according to a second exemplary embodiment;

FIG. 14 is a block diagram illustrating an example of relevant configuration of an electrical system of an infrared camera according to the second exemplary embodiment;

FIG. 15A to FIG. 15D are schematic diagrams illustrating examples of rotated states of a polarizer according to the second exemplary embodiment;

FIG. 16 is an example of a schematic diagram to explain a function of a polarizer according to the second exemplary embodiment;

FIG. 17 is a graph illustrating an example of a detected temperature of a subject against rotation angle of a polarizer according to the second exemplary embodiment;

FIG. 18 is a functional block diagram illustrating an example of an execution section according to the second exemplary embodiment;

FIG. 19 is a flowchart illustrating an example of image processing according to the second exemplary embodiment;

FIG. 20A to FIG. 20C are schematic diagrams illustrating examples of a structure in-built with a testing specimen according to the second exemplary embodiment;

FIG. 21A to FIG. 21C are examples of captured images captured using a cooled camera and using an infrared camera according to the second exemplary embodiment; and

FIG. 22A and FIG. 22B are examples of captured images captured of a subject including reflected light using an infrared camera according to the first exemplary embodiment and using an infrared camera according to the second exemplary embodiment.

### DETAILED DESCRIPTION

### First Exemplary Embodiment

Description follows regarding an example of an exemplary embodiment of the present disclosure, with reference to the drawings. Note that the same or equivalent configuration elements and parts are appended with the same reference numerals in the drawings. Moreover, the dimensions and proportions in the drawings are exaggerated for ease of explanation, and sometimes differ from the actual proportions.

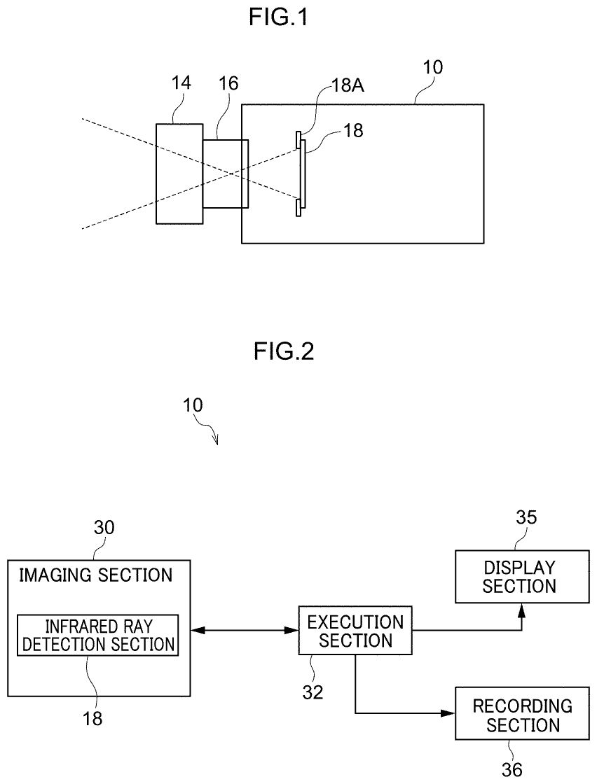

As illustrated in FIG. 1, an infrared camera 10 according to the present exemplary embodiment includes an introduction port 14 to introduce infrared rays into the infrared camera 10, a lens 16, an infrared ray detection section 18, and black body sections 18A. Note that the infrared camera 10 according to the present exemplary embodiment is a fixed type of infrared camera. However, there is no limitation thereto. The infrared camera 10 may be a non-fixed type of infrared camera.

The infrared ray detection section 18 detects infrared rays incident from a subject. The infrared ray detection section 18 according to the present exemplary embodiment is configured by a microbolometer that is an uncooled type thereof. Note that infrared rays are a type of light, and are classified as lying in a wavelength band longer than visible light (for example wavelengths from 360 nm to 830 nm) that humans can see. The wavelengths detected by the infrared camera 10 according to the present exemplary embodiment are wavelengths of from 8 μm to 14 μm. Were wavelengths of from 3 μm to 5 μm also to be wavelengths detected by the infrared camera 10, then although these would be advantageous in that they would not be readily affected by reflected light, they would however be affected by sunlight, and so that would be disadvantageous in being difficult to apply to daytime surveys.

The black body sections 18A cover portions of the infrared ray detection section 18.

Next, description follows regarding relevant configuration of an electrical system of the infrared camera 10 according to the present exemplary embodiment. As illustrated in FIG. 2, the infrared camera 10 according to the present exemplary embodiment includes each configuration of an imaging section 30, an execution section 32, a display section 35, and a recording section 36.

The imaging section 30 includes the infrared ray detection section 18. The imaging section 30 inputs the execution section 32 with data of a captured image that is a thermal image detected by the infrared ray detection section 18.

The execution section 32 is configuration for executing image processing on the captured images captured by the imaging section 30. More specifically, the execution section 32 reads a later-described image processing program 300, and executes later-described image processing.

On being input with an image signal from the execution section 32, the display section 35 displays images captured by the imaging section 30, and captured images on which the later-described image processing has been executed etc. On being input with the image signal from the execution section 32, the recording section 36 records images captured by the imaging section 30, and captured images on which the later-described image processing has been executed, etc.

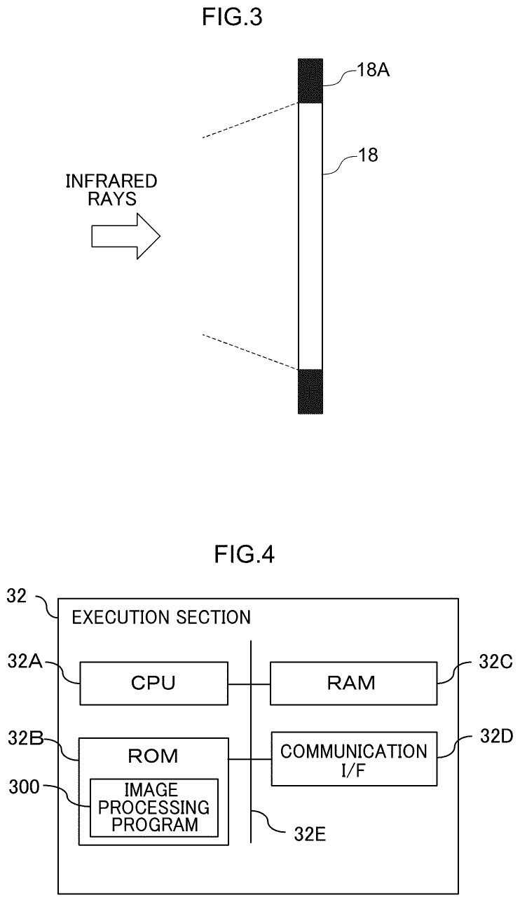

Next, description follows regarding a configuration of the infrared ray detection section 18. The uncooled infrared ray detection section 18 has a tendency to cause the generation of noise in the vertical direction in the captured images. To address this, as illustrated in FIG. 3, the infrared ray detection section 18 according to the present exemplary embodiment is equipped with the black body sections 18A respectively disposed at an upper edge and a lower edge of the infrared ray detection section 18, with these being portions extending in directions intersecting with the direction noise is generate (i.e. intersecting with the vertical direction). More specifically, the black body sections 18A according to the present exemplary embodiment each cover the infrared ray detection section 18 entirely along a direction orthogonal to the noise generation direction, and cover only a portion of the infrared ray detection section 18 in a direction parallel to the noise generation direction. This thereby enables infrared rays to be prevented from being incident to the infrared ray detection section 18 through the upper edge and lower edge, thereby enabling the infrared camera 10 to extract a noise component in the vertical direction.

However, there is no limitation to such an example. For example, the infrared ray detection section 18 may include the black body section 18A only at the upper edge, or only at the lower edge. Moreover, the infrared ray detection section 18 may include plural black body sections 18A in addition to those at the upper edge and lower edge. In cases in which the infrared ray detection section 18 has a tendency to generate noise in the horizontal direction of the captured images, the infrared camera 10 is able to extract a noise component in the horizontal direction by including the black body section 18A at least at one out of the left edge or the right edge.

Next, description follows regarding a hardware configuration of the execution section 32. As illustrated in FIG. 4, the execution section 32 includes a central processing unit (CPU) 32A, read only memory (ROM) 32B, random access memory (RAM) 32C, and a communication interface (I/F) 32D. Each configuration is connected together through a bus 32E so as to be capable of communicating with each other. The CPU 32A is an example of a processor.

The CPU 32A is a central processing unit that performs various programs and controls each section. Namely, the CPU 32A reads a program from the ROM 32B, and performs the program using the RAM 32C as a workspace. The CPU 32A controls each configuration and performs various computational processing according to the program recorded on the ROM 32B. In the present exemplary embodiment the ROM 32B is stored with an image processing program 300.

The ROM 32B is stored with various programs and various data. The RAM 32C serves as a workspace to temporarily store programs and data.

The communication I/F 32D is an interface for communicating with other configuration, such as the imaging section 30, the display section 35, the recording section 36, and the like.

Next, description follows regarding a functional configuration of the execution section 32.

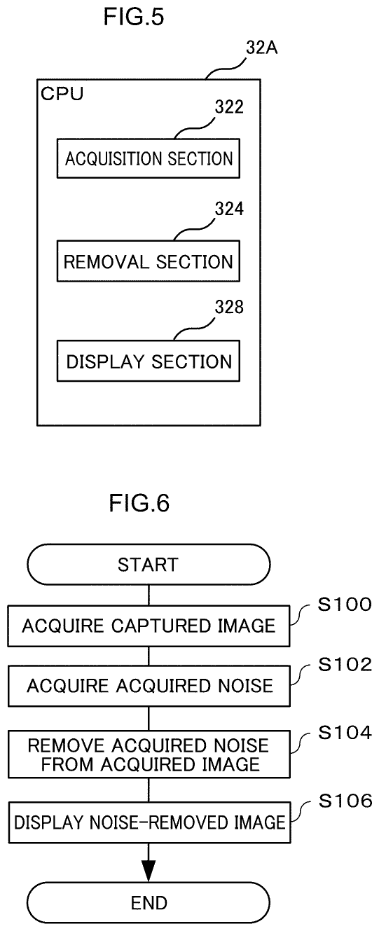

As illustrated in FIG. 5, the execution section 32 includes, as functional configuration, an acquisition section 322, a removal section 324, and a display section 328. These functional configuration are implemented by the CPU 32A reading and executing the image processing program 300 stored on the ROM 32B.

The acquisition section 322 acquires a captured image from the imaging section 30. The acquisition section 322 acquires a noise component from the captured image that was captured at the black body section 18A (hereafter referred to as “noise component”). More specifically, the acquisition section 322 acquires, as the noise component, a value resulting from subtracting an average detected temperature of the black body section 18A from the detected temperature of the black body section 18A.

The removal section 324 removes the noise component acquired from the acquisition section 322 from all of the captured image as acquired by the acquisition section 322.

The display section 328 displays a captured image from which the noise component has been removed by the removal section 324 on the display section 35.

Next, description follows regarding operation of the execution section 32.

FIG. 6 is a flowchart illustrating a flow of image processing by the execution section 32 according to the present exemplary embodiment. The CPU 32A performs the image processing by reading the image processing program 300 from the ROM 32B, and expanding and executing the image processing program 300 in the RAM 32C.

At step S100 of FIG. 6, the CPU 32A acquires a captured image from the imaging section 30. In the following the captured image acquired by the CPU 32A at step S100 is referred to as an acquired image.

At step S102, the CPU 32A acquires a noise component from the acquired image captured at portions covered by the black body sections 18A. In the following the noise component acquired by the CPU 32A is referred to as acquired noise.

At step S104, the CPU 32A removes the acquired noise from all of the acquired image.

At step S106, the CPU 32A displays the acquired image from which the acquired noise has been removed at step S104 as a noise-removed image on the display section 35, and ends the present image processing.

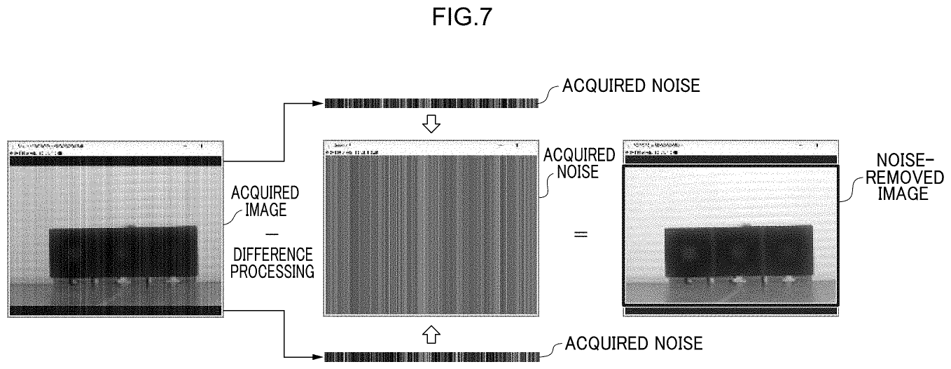

FIG. 7 is a schematic diagram to explain image processing according to the present exemplary embodiment. The left image in FIG. 7 illustrates an example of an acquired image, the central image in FIG. 7 is an example of acquired noise, and the right image in FIG. 7 is an example of a noise-removed image. The CPU 32A extracts noise at the portion of the acquired image covered by the black body section 18A. In the present exemplary embodiment, owing to the noise appearing as extending along the vertical direction, the noise can be acquired for all of the acquired image by extending (interpolating) the noise extracted from the portions covered by the black body sections 18A. This is the acquired noise. The CPU 32A executes difference processing to remove the acquired noise from the acquired image, and displays the noise-removed image on the display section 35. The right image in FIG. 7 has reduced vertical direction noise compared to the left image of FIG. 7.

Next, description follows regarding processing other than the image processing to reduced noise generated in a captured image.

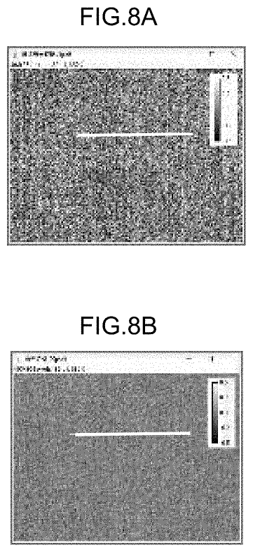

First description follows regarding processing to extend an exposure time. FIG. 8A and FIG. 8B illustrate captured images acquired with the infrared camera 10 according to the present exemplary embodiment by merely changing an exposure time and without executing the image processing. FIG. 8A illustrates a captured image acquired with 43 μs as a standard exposure time, and FIG. 8B illustrates a captured image acquired with 100 μs as an exposure time. The captured image illustrated in FIG. 8B has reduced noise in the vertical direction compared to the captured image illustrated in FIG. 8A. Standard deviations of detected temperature in evaluation lines illustrated by the white lines is FIG. 8A and FIG. 8B are 0.312 in FIG. 8A, and 0.096 in FIG. 8B. Thus extending the exposure time has a noise reducing effect.

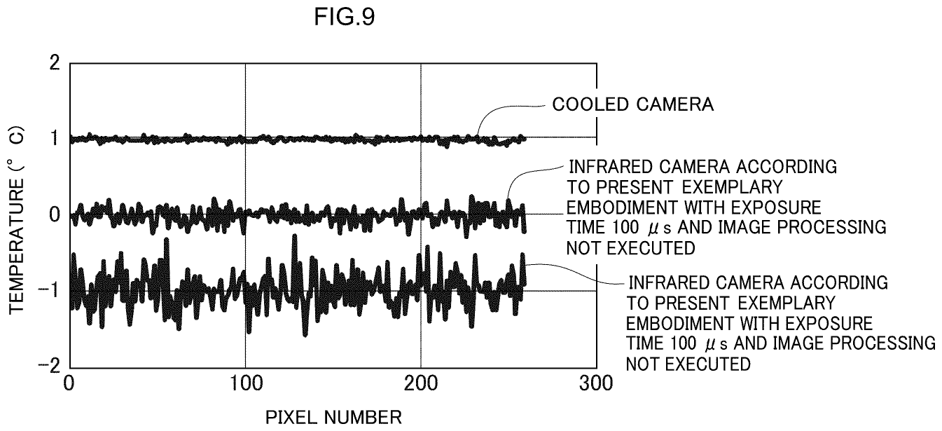

FIG. 9 illustrates detected temperatures for cases in which a subject having a fixed temperature is imaged using a cooled camera and using the infrared camera 10 according to the present exemplary embodiment. The cooled camera has a high temperature resolution compared to an uncooled camera and so is able to reduce noise, however an issue remains in that a cooled camera is more expensive than an uncooled camera. The uppermost line in the graph of FIG. 9 indicates the detected temperature captured for a case in which a cooled camera is employed. The second line from the top in the graph of FIG. 9 indicates the detected temperature captured for a case in which the infrared camera 10 according to the present exemplary embodiment was employed for imaging an exposure time of 100 μs and without executing image processing. Moreover, the lowermost line in the graph of FIG. 9 indicates the detected temperature captured for a case in which the infrared camera 10 according to the present exemplary embodiment was employed at an exposure time of 43 μs and without executing image processing. As is apparent from FIG. 9, without executing image processing the infrared camera 10 according to the present exemplary embodiment is not able to reduce noise to the same extent as a cooled camera even when the exposure time is extended.

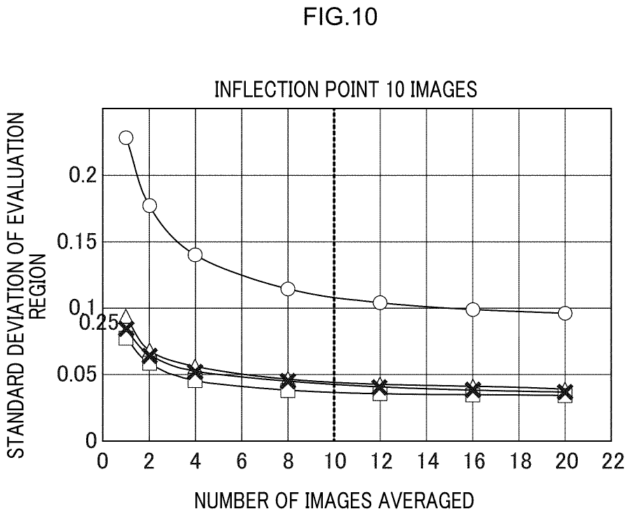

Next, description follows regarding processing to average across plural captured images (hereafter referred to as “averaging processing”). FIG. 10 is a graph illustrating a standard deviation of detected temperature for an evaluation line (hereafter referred to as “evaluation region standard deviation”) against a number of captured images over which averaging processing was performed (hereafter referred to as “number of images averaged”) for the infrared camera 10 according to the present exemplary embodiment and without executing the image processing. In FIG. 10 circular symbols indicate the standard deviation of the evaluation region for a case in which the exposure time was 43 μs, and triangular symbols indicate the standard deviation of the evaluation region for a case in which the exposure time was 100 μs. Moreover, in FIG. 10 the square symbols indicate the standard deviation of the evaluation region for a case in which the exposure time was 150 μs, and the x-shaped symbols indicate the standard deviation of the evaluation region for a case in which the exposure time was 200 μs. As is apparent from FIG. 10, irrespective of the exposure time, increasing the number of images averaged reduces the standard deviation of the evaluation region. However, in cases in which the number of images averaged is 10 or greater, a reduction in the standard deviation of the evaluation region for each increase of one in the number of images averaged is smaller than for cases in which the number of images averaged is less than 10. It is accordingly apparent that using a number of images averaged over of 10 or greater does not significantly change a noise reduction effect from when the number of images averaged is 10 images.

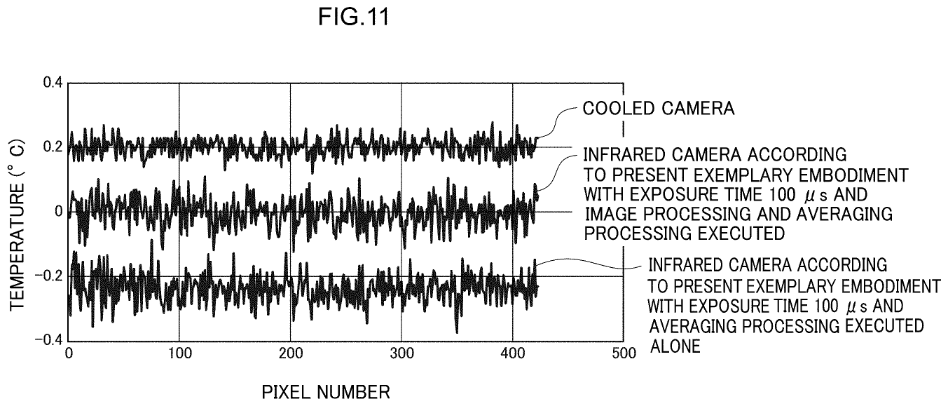

Next, description follows regarding the noise reduction effect owing to executing image processing and averaging processing. FIG. 11 indicates detected temperature for cases in which a subject having a fixed temperature is imaged using a cooled camera and using the infrared camera 10 according to the present exemplary embodiment. The uppermost line in the graph of FIG. 11 indicates the detected temperature captured for a case in which a cooled camera is employed. The second line from the top in the graph of FIG. 11 indicates the detected temperature for a case in which the infrared camera 10 according to the present exemplary embodiment was employed at an exposure time of 100 μs and image processing and averaging processing was executed. The lowermost line in the graph of FIG. 11 indicates the detected temperature for a case in which the infrared camera 10 according to the present exemplary embodiment was employed at an exposure time of 100 μs and averaging processing was executed alone. It is apparent from FIG. 11 that the standard deviation of detected temperature is not able to be reduced to the same extent as a cooled camera even when the exposure time is extended with the infrared camera 10 according to the present exemplary embodiment (namely, an infrared camera including an uncooled infrared ray detection section) and image processing and averaging processing is also executed.

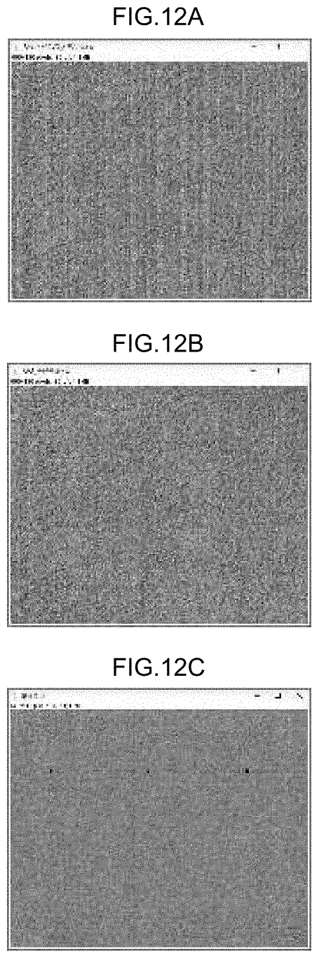

FIG. 12A, FIG. 12B, and FIG. 12C illustrate captured images captured using a cooled camera and the infrared camera 10 according to the present exemplary embodiment. FIG. 12A illustrates a captured image by the infrared camera 10 according to the present exemplary embodiment at an exposure time of 100 us with averaging processing executed alone. FIG. 12B illustrates a captured image by the infrared camera 10 according to the present exemplary embodiment performed at an exposure time of 100 us and with both image processing and averaging processing executed. FIG. 12C illustrate a captured image captured using a cooled camera. The standard deviations of detected temperature in the evaluation line as indicated by the white lines in FIG. 12A, FIG. 12B, and FIG. 12C are: 0.047 in FIG. 12A; 0.045 in FIG. 12B; and 0.028 in FIG. 12C. It is accordingly apparent that the standard deviation of detected temperature is not able to be reduced to the same extent as a cooled camera even when the exposure time is extended with the infrared camera 10 according to the present exemplary embodiment and image processing and averaging processing is also executed. However, the vertical direction noise is reduced in the captured image illustrated in FIG. 12B compared to the captured image illustrated in FIG. 12A. Moreover, the vertical direction noise does not change in the captured image illustrated in FIG. 12B compared to the captured image illustrated in FIG. 12C. It is accordingly apparent that, outwardly, the noise can be reduced to the same extent as a cooled camera by extending the exposure time with the infrared camera 10 according to the present exemplary embodiment and executing the image processing and averaging processing.

As described above, the infrared camera 10 according to the first exemplary embodiment includes the imaging section 30 that images a subject, and the execution section 32 that executes image processing on captured images. The imaging section 30 is equipped with the uncooled infrared ray detection section 18 for detecting infrared rays radiated from the subject, and the black body sections 18A that cover parts of the infrared ray detection section 18. Moreover, the execution section 32 also includes the acquisition section 322 that acquires a captured image and acquires a component of noise extracted from a captured image captured from portions covered by the black body sections 18A, and incudes the removal section 324 that removes a noise component from all of the captured image. This thereby enables the noise in the captured image to be reduced in comparison to hitherto by using an uncooled camera that is relatively inexpensive compared to a cooled camera.

Moreover, the wavelength detected by the infrared camera 10 according to the present exemplary embodiment is a wavelength from 8 μm to 14 μm, and so the infrared camera 10 can be employed irrespective of whether or not it is day or night.

Note that the infrared camera 10 according to the first exemplary embodiment includes the black body sections 18A covering portions of the infrared ray detection section 18. However, there is no limitation to such an example. The black body sections 18A may be omitted in the infrared camera 10 according to the first exemplary embodiment. In such cases, the acquisition section 322 acquires a noise component by generating a blurred image from the captured image using an averaging filter, and taking a difference between the captured image and the blurred image. The removal section 324 removes the thus acquired noise component from all of the captured image.

### Second Exemplary Embodiment

In the first exemplary embodiment the infrared camera 10 is not equipped with a polarizer. In the present exemplary embodiment, the temperature is measured while rotating a polarizer and an approximation to a cosine wave is employed by an infrared camera 10 to remove infrared rays that have been reflected by the subject (hereafter referred to as “reflected rays”). Description follows regarding points of difference to the first exemplary embodiment.

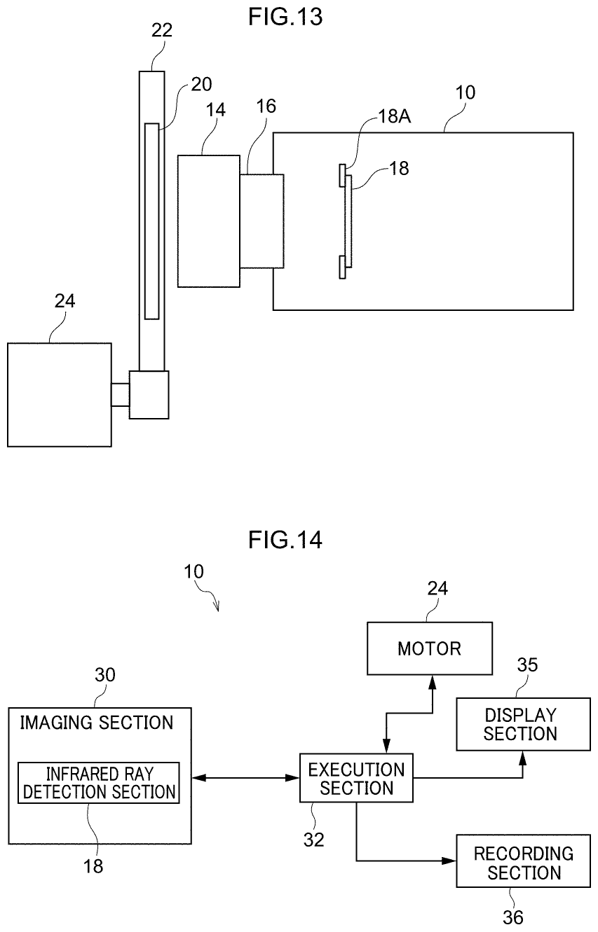

As illustrated in FIG. 13, the infrared camera 10 according to the present exemplary embodiment differs from the first exemplary embodiment in that it includes a polarizer 20, a support plate 22, and a motor 24.

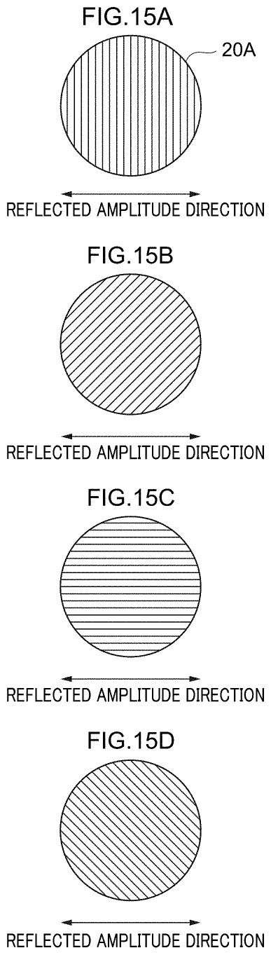

The polarizer 20 is an optical element having properties of letting light oscillating in a single direction alone pass through, and blocking light oscillating in directions other than this direction. As illustrated in FIG. 15A to FIG. 15D, the polarizer 20 includes fine vertical line shaped grid wires 20A disposed along a specific direction. The plural grid wires 20A are arranged parallel to each other.

The support plate 22 has, for example, a circular disc shape, and rotates in a state in which the polarizer 20 is supported thereby.

The motor 24 serving as a drive section rotates the polarizer 20 by driving an external periphery of the circular disc shaped support plate 22.

Note that the infrared camera 10 according to the present exemplary embodiment differs from the infrared camera 10 according to the first exemplary embodiment in not being limited to an uncooled camera. Namely, the infrared camera 10 according to the present exemplary embodiment may be applied to a cooled camera.

Next, description follows regarding relevant configuration of an electrical system of the infrared camera 10 according to the present exemplary embodiment. As illustrated in FIG. 14, the infrared camera 10 according to the present exemplary embodiment differs from the first exemplary embodiment in including the motor 24.

The execution section 32 controls the motor 24 so as to rotate the polarizer 20 supported by the support plate 22.

FIG. 15A to FIG. 15D illustrate rotated states of the polarizer 20. FIG. 15A is a state in which a rotation angle of the polarizer 20 is 0°, and this position of the polarizer 20 is a reference position. FIG. 15B is a state in which the rotation angle of the polarizer 20 with respect to the reference position is 45°. FIG. 15C is a state in which the rotation angle of the polarizer 20 with respect to the reference position is 90°. FIG. 15D is a state in which the rotation angle of the polarizer 20 with respect to the reference position is 135°. In cases in which the rotation angle is 0°, the amplitude direction of reflected light (hereafter referred to as “reflected amplitude direction”) is orthogonal to the direction of the grid wires 20A, and the reflected light passes through the polarizer 20. However, in cases in which the rotation angle is 90°, the reflected amplitude direction is parallel to the direction of the grid wires 20A, and so the polarizer 20 removes the reflected light.

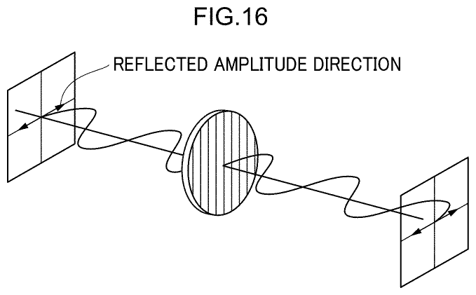

FIG. 16 is a schematic diagram to explain a function of the polarizer 20. In FIG. 16, the rotation angle of the polarizer 20 is 0°. As illustrated in FIG. 16, the polarizer 20 lets reflected light W pass through owing to the reflected amplitude direction being orthogonal to the direction of the grid wires 20A.

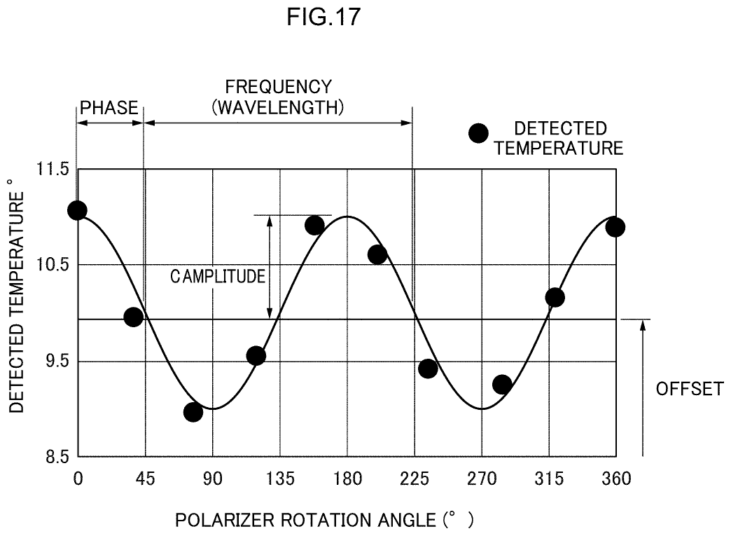

FIG. 17 illustrates an example of detected temperature of a subject against rotation angle of the polarizer 20. The circular symbols in FIG. 17 indicate detected temperatures as detected from plural captured images captured while rotating the polarizer 20 through 360°. The cosine wave in FIG. 17 indicates a temperature estimation model to estimate detected temperature. The temperature estimation model is a cosine function as expressed by Equation (1). In Equation (1), Yn is a detected temperature, A is an amplitude, δ is a phase difference, θ is a rotation angle of the polarizer 20, n is a frequency, and B is an offset.

Yn=A cos(δ+θ×n)+B Equation (1)

It is apparent from FIG. 17 that the detected temperature is highest in cases in which the rotation angle is 0°, 180°, and 360° owing to the polarizer 20 letting the most reflected light pass through, and the detected temperature is lowest in cases in which the rotation angle is 90° and 270° owing to the polarizer 20 removing the reflected light. The infrared camera 10 according to the present exemplary embodiment estimates the detected temperature in a state in which the rotation angle is 90° and 270°; namely, in a state in which the reflected light has been removed to the greatest extent, by subtracting the absolute value of the amplitude A from the offset B in the temperature estimation model. Note that the infrared camera 10 may estimate the detected temperature in a state in which the reflected light has been removed to the greatest extent by substituting 90° or 270° for 0 in the temperature estimation model. In the following, an estimate value of detected temperature in a state in which reflected light has been removed to the greatest extent is called an “estimated temperature”. Note that in cases in which the polarizer 20 is able to remove all of the reflected light, the detected temperature is the detected temperature in a state in which all the reflected light has been removed.

Next, description follows regarding a functional configuration of the execution section 32.

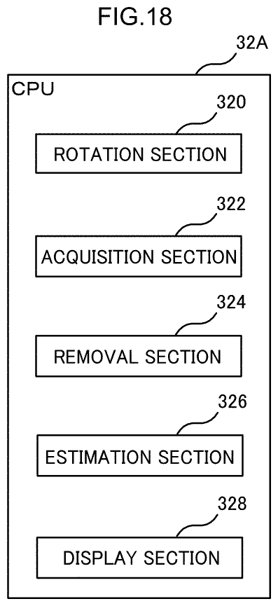

As illustrated in FIG. 18, the execution section 32 differs from the first exemplary embodiment in additionally including a rotation section 320 and an estimation section 326.

The rotation section 320 controls the motor 24 so as to rotate the polarizer 20 supported by the support plate 22 by 180° or more. In the present exemplary embodiment, the rotation section 320 controls the motor 24 so as to rotate the polarizer 20 at a constant speed in a circumferential direction.

The acquisition section 322 differs from the first exemplary embodiment in that it acquires plural captured images from imaging of the same subject during rotation of the polarizer 20. In the present exemplary embodiment the acquisition section 322 acquires captured images at each instance of rotation by a specific angle (for example 40°) of the polarizer 20. However, there is no limitation to such an example. For example, if the polarizer 20 is rotated at a constant speed then the acquisition section 322 may acquire a captured image not in terms of a relationship to the angle of the polarizer 20, but rather by acquisition each time a specific period of time (for example 0.1 seconds) elapses.

Moreover, the acquisition section 322 differs from in the first exemplary embodiment in that, from the plural captured images, it acquires for each pixel a detected temperature of the subject and also the rotation angle of the polarizer 20 when the detected temperature was detected.

The estimation section 326 estimates a temperature estimation model based on the detected temperature of the subject as acquired by the acquisition section 322 and based on the rotation angle of the polarizer 20 in cases in which the detected temperature has been detected. The estimation section 326 then estimates the estimated temperature based on the temperature estimation model.

Next, description follows regarding operation of the execution section 32.

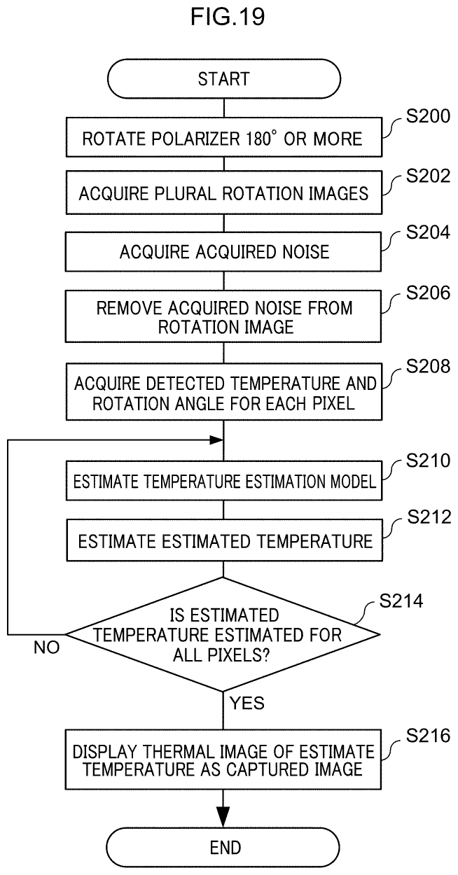

FIG. 19 is a flowchart illustrating a flow of image processing by the execution section 32 according to the present exemplary embodiment. The CPU 32A reads the image processing program 300 from the ROM 32B, and performs the image processing by expanding and executing the image processing program 300 in the RAM 32C.

At step S200 of FIG. 19, the CPU 32A rotates the polarizer 20 by 180° or more by controlling the motor 24.

At step S202, the CPU 32A acquires plural captured images captured of the same subject while rotating the polarizer 20. In the following the captured images acquired by the CPU 32A at step S202 are called rotation images.

At step S204, the CPU 32A acquires acquired noise from the rotation images captured at portions covered by the black body sections 18A.

At step S206, the CPU 32A removes the acquired noise from all of the rotation images.

At step S208, from all of the acquired rotation images the CPU 32A acquires a detected temperature for each pixel and acquires a rotation angle of the polarizer 20 for when the detected temperature was detected.

At step S210, the CPU 32A estimates the temperature estimation model by performing non-linear recursion based on the detected temperatures acquired at step S208 and based on the rotation angles of the polarizer 20.

At step S212, the CPU 32A estimates the estimated temperature by subtracting an absolute value of the amplitude A from the offset B in the temperature estimation model as estimated at step S210.

At step S214, the CPU 32A determines whether or not the estimated temperature has been estimated for all of the pixels of the rotation image. The CPU 32A transitions to step S216 in cases in which the estimated temperature has been estimated for all of the pixels of the rotation image (step S214: YES). However, the CPU 32A returns to step S210 when the estimated temperature has not been estimated for all of the pixels of the rotation image (step S214: NO).

At step S216, the CPU 32A displays a thermal image at the estimated temperature that was estimated on the display section 35 as a captured image captured by the imaging section 30, and then ends the present image processing.

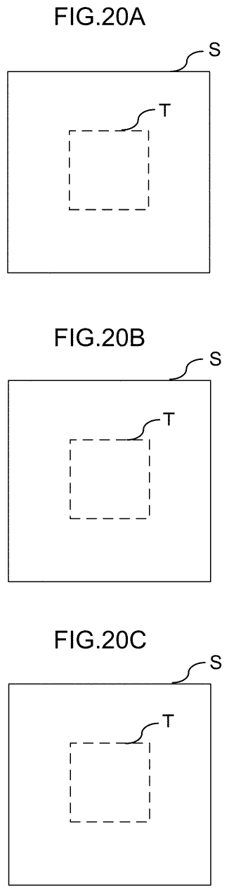

Next, description follows regarding a noise reduction effect owing to executing the image processing according to the present exemplary embodiment. FIG. 20A to FIG. 20C each illustrate a structure S having a testing specimen T in-built therein. The broken lines in FIG. 20A to FIG. 20C indicate the testing specimen T, and the solid lines therein indicate the structure S. FIG. 20A illustrates a state in which the testing specimen T has been in-built at a position with a covering depth of 2 cm, FIG. 20B illustrates a state in which the testing specimen T has been in-built at a position with a covering depth of 3 cm, and FIG. 20C illustrates a state in which the testing specimen T has been in-built at a position with a covering depth of 4 cm. Note that a width and a height of the testing specimen T are both 150 mm.

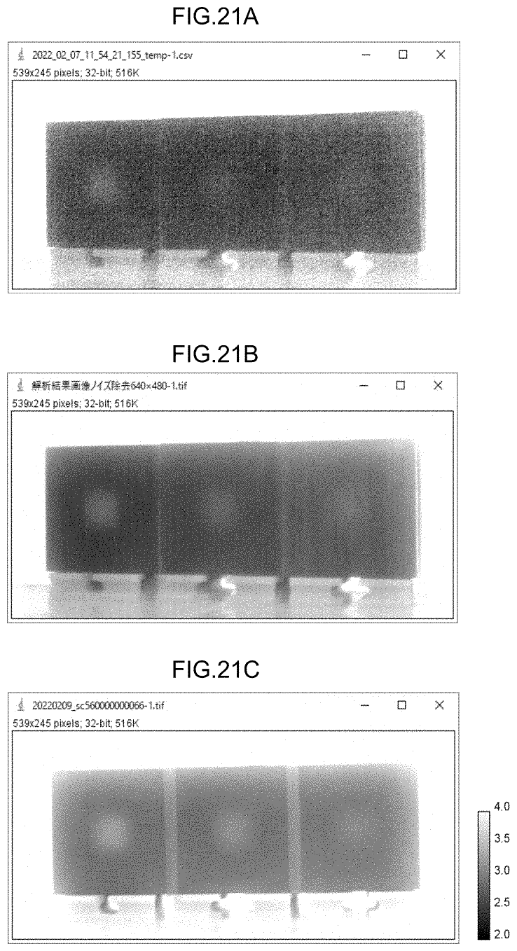

FIG. 21A to FIG. 21C illustrate captured images for cases in which the structure S illustrated in FIG. 20A to FIG. 20C was respectively captured using a cooled camera and using the infrared camera 10 according to the present exemplary embodiment. FIG. 21A illustrated a captured image captured by the infrared camera 10 without execution of the image processing according to the present exemplary embodiment. FIG. 21B illustrates a captured image captured by the infrared camera 10 with execution of the image processing according to the present exemplary embodiment. Note that initial values of the temperature estimation model as estimated in the image processing are set with the frequency n at a value of twice the number of rotations of the polarizer 20, the phase difference δ at 0, the amplitude A as the gradient of the detected temperature Yn, and the offset B as the average value of the detected temperature. Moreover, FIG. 21C illustrates a captured image captured by a cooled camera.

The captured images illustrated in FIG. 21A have more noise than the captured images illustrated in FIG. 21B and FIG. 21C. Moreover, a temperature difference between the testing specimen T in-built at a position with a covering depth of 4 cm at the left image of FIG. 21A and the structure S is detected as being about 0.1° C. Namely, the uncooled camera without execution of the image processing according to the present exemplary embodiment was not able to detect the testing specimen T in-built at a position with a covering depth of 4 cm owing to there being a lot of noise.

However, there is less noise in the captured images illustrated in FIG. 21B than in the captured images illustrated in FIG. 21A, and there is only noise generated to about the same extent as in the captured images illustrated in FIG. 21C. Moreover, in FIG. 21B and FIG. 21C, a temperature difference between the testing specimen T in-built at a position with a covering depth of 4 cm in FIG. 21B and FIG. 21C and the structure S is detected as being about 3.0° C. Thus it is apparent that even though an uncooled camera is employed, by executing the image processing according to the present exemplary embodiment noise can be removed to achieve a similar level to that of a cooled camera.

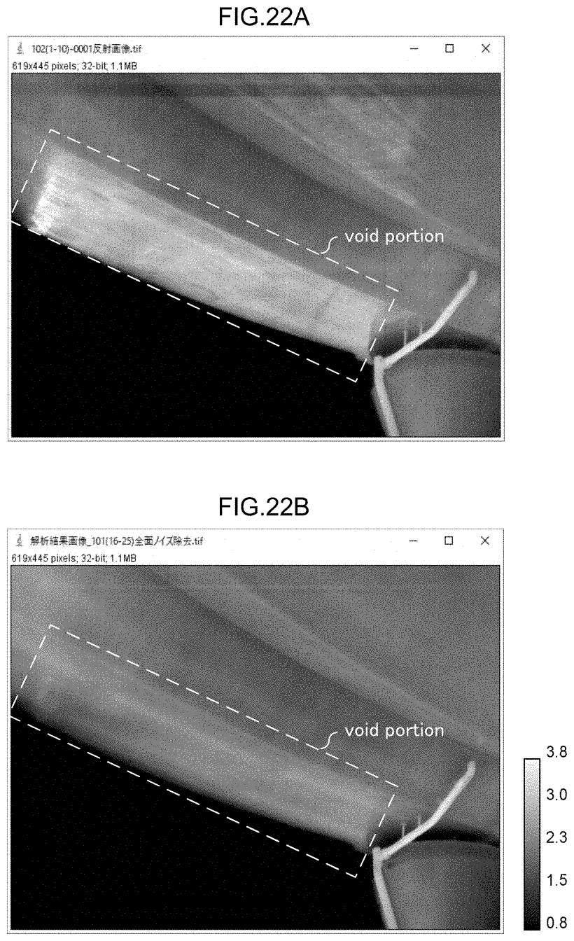

Moreover, FIG. 22A and FIG. 22B illustrate captured images of a void that is an internal structure inside a bridge respectively captured using an infrared camera according to the first exemplary embodiment and an infrared camera according to the second exemplary embodiment. FIG. 22A illustrates a captured image by an infrared camera according to the first exemplary embodiment from which noise has been removed. FIG. 22B illustrates a captured image by the infrared camera 10 according to the present exemplary embodiment from which noise has been removed and on which processing to remove reflected light has been executed by rotating the polarizer 20. Namely, the FIG. 22A and the FIG. 22B differ from each other in whether or not the processing to remove reflected light has been executed by rotating the polarizer 20. Moreover, the portions surrounded by the broken white lines in FIG. 22A and FIG. 22B are portions where a void is present (hereafter referred to as “void portions”). The void portion in FIG. 22A overlaps with the reflected light, and a temperature difference generated by the void is not able to be confirmed. However, owing to being able to remove the reflected light at the void portion in FIG. 22B, the temperature difference generated by the void is able to be confirmed. This means that executing the image processing for the infrared camera 10 according to the present exemplary embodiment enables a temperature difference of a structure and damage in the interior of the bridge to be detected even when reflected light is generated.

As described above, the infrared camera 10 according to the second exemplary embodiment is further equipped with the polarizer 20 and the motor 24 for rotating the polarizer 20. The execution section 32 according to the second exemplary embodiment is also further equipped with the rotation section 320 and the estimation section 326. The rotation section 320 controls the motor 24 so as to rotate the polarizer 20 by 180° or more. The acquisition section 322 also acquires the plural rotation images captured of the same subject during rotation of the polarizer 20. Moreover, the estimation section 326 estimates the estimation model based on the detected temperature of the subject detected from the plural rotation images and based on the rotation angle of the polarizer 20 when the detected temperatures were detected, and then estimates the estimated temperature based on the temperature estimation model. This thereby enables the reflected light to be reduced compared to hitherto. Thus in, for example, a damage survey of a concrete structure, an external wall inspection of a building, or the like, a possibility can be reduced of misdetection of a temperature difference as being internal damage, when the temperature difference is actually owing to reflected light, which is reflected light from a thermal environment around a survey subject reflected into the infrared camera 10. Moreover, the possibility can also be reduced of internal damage being overlooked owing to reflections of reflected light overlapping with internal damage.

Note that the present disclosure is not limited to the exemplary embodiments described above, and various modifications and applications are possible within a range not departing from the spirit of the present disclosure.

For example, the execution section 32 of the exemplary embodiment described above is inbuilt into the infrared camera 10. However, there is no limitation thereto. For example, the execution section 32 may be configured as a separate body to the infrared camera 10.

Moreover, in the exemplary embodiment described above the black body sections 18A are provided so as to cover two locations of the infrared ray detection section 18, these being at an upper edge and a lower edge thereof at portions extending in a direction intersecting with a direction of noise generation (for example the vertical direction). However, there is no limitation thereto. The black body sections 18A may be provided so as to cover the infrared ray detection section 18 at one location or three or more locations. Moreover, the black body section 18A does not necessarily cover an end of the infrared ray detection section 18. As long as the black body section 18A extends in a direction intersecting with the direction of noise generation then it may be provided so as to cover the infrared ray detection section 18 at a place separated from an end thereof. Moreover, although in the exemplary embodiment described above an example has been described of a case in which the noise extends along a vertical direction of the page, the black body sections 18A may be provided so as to extend in a direction intersecting with the direction of noise extension; namely, so as to extend in the vertical direction, in cases in which the noise extends along a horizontal direction.

Moreover, the various processing executed in each of the exemplary embodiments described above by the CPU 32A reading in software (a program) may be executed by various processors other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The various processing described above may be executed by any one of these various types of processors, or may be executed by a combination of two or more of the same type or different types of processors (such as plural FPGAs, or a combination of a CPU and an FPGA). The hardware structure of these various types of processors is more specifically an electric circuit combining circuit elements such as semiconductor elements.

Moreover, although in each of the exemplary embodiments described above the image processing program 300 was described as being in a format pre-stored (installed) on the ROM 32B, there is no limitation thereto. The program may be provided in a format recorded on a recording medium such as a compact disc read only memory (CD-ROM), digital versatile disc read only memory (DVD-ROM), universal serial bus (USB) memory, or the like. Moreover, the program may be provided in a format downloadable from an external device over a network.

Moreover, the flow of processing described in each of the exemplary embodiments described above is merely an example thereof, and redundant steps may be omitted, new steps may be added, and the processing sequence may be swapped around within a range not departing from the spirit of the present disclosure.

Moreover, each configuration of the infrared camera 10 as described in the exemplary embodiment described above is merely an example thereof, and various modifications may be implemented thereto according to circumstances within a range not departing from the spirit of the present disclosure.

What is claimed is:

1. An infrared camera, comprising:
an imaging section that images a subject; and
an execution section that executes image processing on a captured image captured by the imaging section, wherein:
the imaging section includes:
an uncooled infrared ray detection section that detects infrared rays radiated from the subject, and
a black body section that covers a portion of the infrared ray detection section, and
the execution section includes a processor, wherein the processor is configured to:
acquire the captured image and a component of noise extracted from the captured image captured at the portion covered by the black body section, and
remove the noise component from all of the captured image.

2. The infrared camera of claim 1, wherein the black body section covers a portion of the infrared ray detection section extending in a direction intersecting with a direction in which the noise is generated.

3. The infrared camera of claim 2, wherein the black body section covers the infrared ray detection section entirely in a direction orthogonal to the noise generation direction and covers the infrared ray detection section only partially in a direction parallel to the noise generation direction.

4. The infrared camera of claim 1, further comprising:
a polarizer and a drive section for rotating the polarizer,
wherein the processor is configured to:
rotate the polarizer by 180° or more by controlling the drive section,
acquire a plurality of the captured images that capture the same subject while rotating the polarizer,
estimate a temperature estimation model expressed by a cosine function for estimating a temperature of the subject based on respective detected temperatures of the subject as detected from the plurality of the captured images and based on a rotation angle of the polarizer when these respective detected temperatures were detected, and
estimate the detected temperature based on the temperature estimation model for a state in which the infrared rays reflected by the subject have been removed to the greatest extent.

5. The infrared camera of claim 4, wherein the processor rotates the polarizer at a constant speed.

6. The infrared camera of claim 4, wherein the processor estimates the detected temperature based on the temperature estimation model for a state in which all of the infrared rays reflected by the subject have been removed.

7. The infrared camera of claim 4, wherein the processor estimates a value obtained by subtracting an absolute value of an amplitude from an offset in the temperature estimation model as being the detected temperature for the state in which the infrared rays reflected by the subject have been removed to the greatest extent.

8. An image processing method, according to which a computer performs processing comprising:
acquiring a captured image captured by an imaging section provided at an infrared camera;
acquiring a noise component extracted from the captured image captured at a portion of an uncooled infrared ray detection section provided at the imaging section, the uncooled infrared ray detection section being for detecting infrared rays radiated from a subject and the portion being covered by a black body section; and
removing the noise component from all of the captured image.

9. A non-transitory recording medium storing an image processing program executable by a computer to perform processing comprising:
acquiring a captured image captured by an imaging section provided at an infrared camera;
acquiring a noise component extracted from the captured image captured at a portion of an uncooled infrared ray detection section provided at the imaging section, the uncooled infrared ray detection section being for detecting infrared rays radiated from a subject, and the portion being covered by a black body section; and
removing the noise component from all of the captured image.
